(19) United States
(12) Patent Application Publication
(10) Pub. No.: US 2014/0069940 A1
(43) Pub. Date: Mar. 13, 2014

(54) REINFORCED OIL PAN ASSEMBLY AND METHOD THEREOF

(71) Applicants: Leonard Barry Griffiths, Fenton, MI (US); David R. Staley, Flushing, MI (US)

(72) Inventors: Leonard Barry Griffiths, Fenton, MI (US); David R. Staley, Flushing, MI (US)

(73) Assignee: GM GLOBAL TECHNOLOGY OPERATIONS LLC, Detroit, MI (US)

(21) Appl. No.: 13/611,404

(22) Filed: Sep. 12, 2012

(51) Int. Cl. B65D 1/42; B31B 1/14

(52) U.S. Cl. 220/659; 493/56

(57) ABSTRACT

A reinforced oil pan assembly includes a reinforcement component and an overmold component that are combined via an injection molding process utilizing a standard oil pan mold. The reinforcement component adds structural stiffness to the oil pan assembly in order to alleviate NVH characteristics, such as powertrain bending. The reinforcement component is placed within the oil pan mold, and is embedded within the overmold component after the injection molding process. The reinforcement component has at least one rear wall and at least two side walls, each of which may include apertures and/or ribs to enhance the bond between the reinforcement component and the overmold component. The reinforcement component may be made of a layered-sheet composite overmolded with a base polymer, a metallic material, and the like.

### TECHNICAL FIELD

The present invention relates to an oil pan assembly with a structural reinforcement component, and a method of manufacturing the same.

### BACKGROUND

Automobiles and vehicles experience different noise, vibration, and harshness (NVH) characteristics, including, but not limited to, powertrain bending. One manner in which powertrain bending may be alleviated is by structural reinforcement of the vehicle, particularly its parts. One such part is the oil pan, which is secured to the lower end of the engine block and to the transmission casing.

### SUMMARY

A reinforced oil pan assembly is provided. The oil pan assembly includes at least one reinforcement component and an overmold component that are combined through an injection molding process utilizing a standard oil pan mold. The at least one reinforcement component includes at least one rear wall, and at least two side walls that are configured to fit in the oil pan. In the simplest form of the reinforcement component, the walls may be flat surfaces. In other embodiments, at least a portion of at least one of the walls may be undulated to form ribs and/or have protrusions or mounds to enhance the bond between the reinforcement component and the overmold component. Similarly, in other embodiments, at least one of the walls may include apertures through which the material of the overmold component may flow during the injection molding process to enhance the bonding. In other embodiments, the walls may include both ribs and apertures. The reinforcement component provides structural reinforcement to the oil pan to alleviate such NVH characteristics as powertrain bending.

A method for manufacturing a reinforced oil pan assembly is also provided. The method includes first forming a reinforcement component in accordance with any of the embodiments described above. This may involve cutting the overall, unformed shape of the reinforcement component from a sheet of material, and bending it accordingly to form the final configuration, which may be dependent upon the mold of the oil pan. The reinforcement component is then positioned in a desired location in the mold. These steps may be repeated as many times as there are desired reinforcement components for a given oil pan assembly. Finally, a material is injected into the mold to form the overmold component, where the reinforcement component is embedded at least partially within the overmold component.

A structural insert for reinforcing an oil pan is also provided. The structural insert is similar to the reinforcement component of the embodiments above. The structural insert is bonded with an overmold of the oil pan in an injection molding process, such that the structural insert is embedded at least partially within the overmold, thereby providing structural reinforcement for the oil pan. The structural insert includes at least one rear wall and at least two side walls. At least a portion of at least one of the walls is undulated to form ribs to enhance the bond between the structural insert and the overmold.

The above features and advantages, and other features and advantages, of the present invention are readily apparent from the following detailed description of some of the best modes and other embodiments for carrying out the invention, which is defined solely by the appended claims, when taken in connection with the accompanying drawings.

### BRIEF DESCRIPTION OF THE DRAWINGS

FIG. 1 is a schematic, fragmentary perspective view of a reinforced oil pan assembly with cut-away sections to reveal a reinforcement component embedded within an overmold component;

FIG. 2 is a schematic, perspective view of the reinforcement component of the oil pan assembly of FIG. 1;

FIG. 3 is a schematic, vertical section of a wall of the reinforcement component of FIG. 2;

FIG. 4 is a schematic, plan view of the reinforcement component of FIG. 2 in an unassembled state;

FIG. 5 is a schematic, perspective view of a reinforcement component in accordance with another embodiment of the present invention;

FIG. 6 is a schematic, plan view of the reinforcement component of FIG. 5 in an unassembled state; and

FIG. 7 is a schematic flow diagram illustrating a method of manufacturing the oil pan assembly of FIG. 1.

### DETAILED DESCRIPTION

Those having ordinary skill in the art will recognize that terms such as “above,” “below,” “upward,” “downward,” et cetera, are used descriptively of the figures, and do not represent limitations on the scope of the invention, as defined by the appended claims. Any numerical designations, such as “first” or “second” are illustrative only and are not intended to limit the scope of the invention in any way.

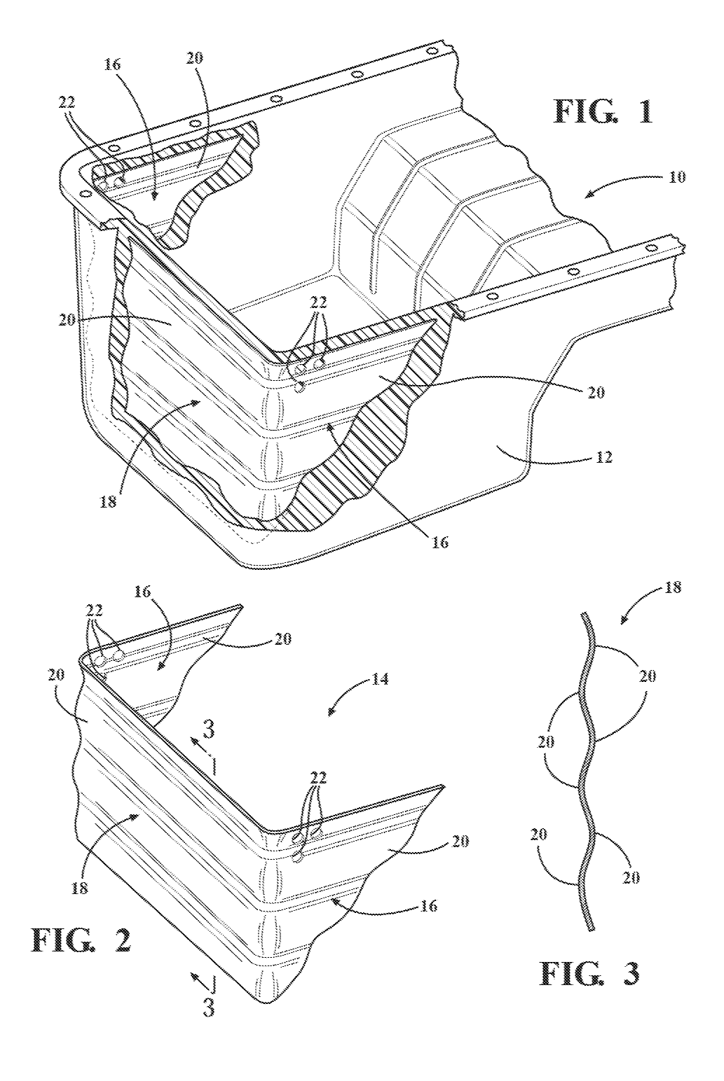

Referring to the drawings, wherein like reference numbers correspond to like or similar components wherever possible throughout the several figures, there is shown in FIG. 1 a schematic, fragmentary perspective view drawing of a reinforced oil pan assembly 10. The oil pan assembly 10 includes an overmold component 12 and a reinforcement component 14 that are combined through an injection molding process utilizing a standard oil pan mold. The reinforcement component 14 is depicted in FIG. 2, and is described in more detail hereinafter. The reinforcement component 14 is generally embedded at least partially within the overmold component 12. Sections of the overmold component 12 are cut away in FIG. 1 in order to reveal portions of the reinforcement component 14.

While FIG. 1 depicts an oil pan assembly, it should be appreciated that the present invention may be applicable to any injection-molded part, particularly those found in vehicles. In addition, oil pans may come in different shapes, sizes, and configurations, such as when used for different types of vehicles. Therefore, the shape, size, and configuration of the overmold component 12, and subsequently, the reinforcement component 14, may vary for different oil pans or other injection-molded parts.

Referring to FIG. 2, the reinforcement component 14 has two side walls 16 and a rear wall 18, with each wall having an interior surface facing the inside of the oil pan assembly 10 and an exterior surface facing the outside of the oil pan assembly 10. While three walls are depicted, it should be appreciated that any number of walls, including just one, or more, are contemplated to suit different oil pans or other injection-molded parts, as explained above. The side walls 16 are connected to the rear wall 18 at substantially right angles. However, the walls may be formed at any angle in order to suit the particular oil pan or other injection-molded part. The corners formed at the connection point of the walls may be filleted, non-filleted, or chamfered. In another embodiment, the side walls 16 and the rear wall 18 may be separate components where they do not interact with each other to form corners.

The side walls 16 are generally triangular in shape to resemble gusset plates and provide structural reinforcement to the oil pan assembly 10 in a similar fashion. In other embodiments, the side walls 16 may resemble any other geometric shape, including, but not limited to, a rectangle, a trapezoid, and the like. The side walls alternatively may be rounded or have an irregular shape and contour.

The side walls 16 and rear wall 18 may be undulated, forming ribs 20 on both the interior and exterior surfaces in a wave-like configuration, as illustrated by the vertical section of the rear wall 18 in FIG. 3. The ribs 20 are generally uniform in size with a height that may range from 2 mm to 25 mm. The height and width of each rib 20 may vary from each other. The ribs 20 may be substantially parallel with respect to each other. Where the side walls 16 are triangular in shape, the ribs 20 may be substantially parallel to the sloped edge. It should be understood that any variation of the size, shape, and undulations of the ribs 20 is sufficient to enhance the bonding between the overmold component 12 and the reinforcement component 14. For example, in one embodiment, the ribs 20 may resemble ridges to form an accordion-like pattern instead of a wave-like pattern. In another embodiment, in lieu of or in addition to undulated surfaces, the side walls 16 and rear wall 18 may have protrusions or mounds spread throughout the interior surface and/or the exterior surface. In other embodiments, the ribs 20 may be on just the interior surface or just the exterior surface of each wall. Also, the ribs 20 may cover an entire surface of each wall or just portions of a surface of each wall.

The side walls 16 may further have apertures 22. During the injection molding process, the material of the overmold component being injected into the oil pan mold flows through the apertures 22, further enhancing the bond between the overmold component 12 and the reinforcement component 14. While three apertures 22 are depicted in each side wall 16, it should be appreciated that there may be any number of apertures in the side walls 16. In addition, the rear wall 18 may also have any number of apertures 22. The diameter of the apertures 22 may range from 2 mm to 25 mm. However, one of ordinary skill in the art will appreciate that the size, quantity, and location of the apertures 22 should be optimized to balance the additional bonding benefits with the loss of structural stiffness of the reinforcement component 14 resulting from the apertures 22.

The material of the reinforcement component 14 may be a layered-sheet composite, such as a matrix of layered fiber including, but not limited to, carbon fiber, hemp fiber, and the like, overmolded, in a separate overmold process separate from the present invention, with a base polymer. In other embodiments, the material may be a metallic substance, including, but not limited to, sheet metal, foam metal, and the like.

Referring to FIG. 4, the reinforcement component 14 is shown in an unassembled or unformed state. As depicted in FIG. 7 and described in method 200 hereinafter, the reinforcement component in its unassembled or unformed state may be cut from a sheet of material. The resulting piece may then be bent to form the final configuration of the reinforcement component 14. The locations at which the cut piece should be bent are indicated by dashed lines in FIG. 4.

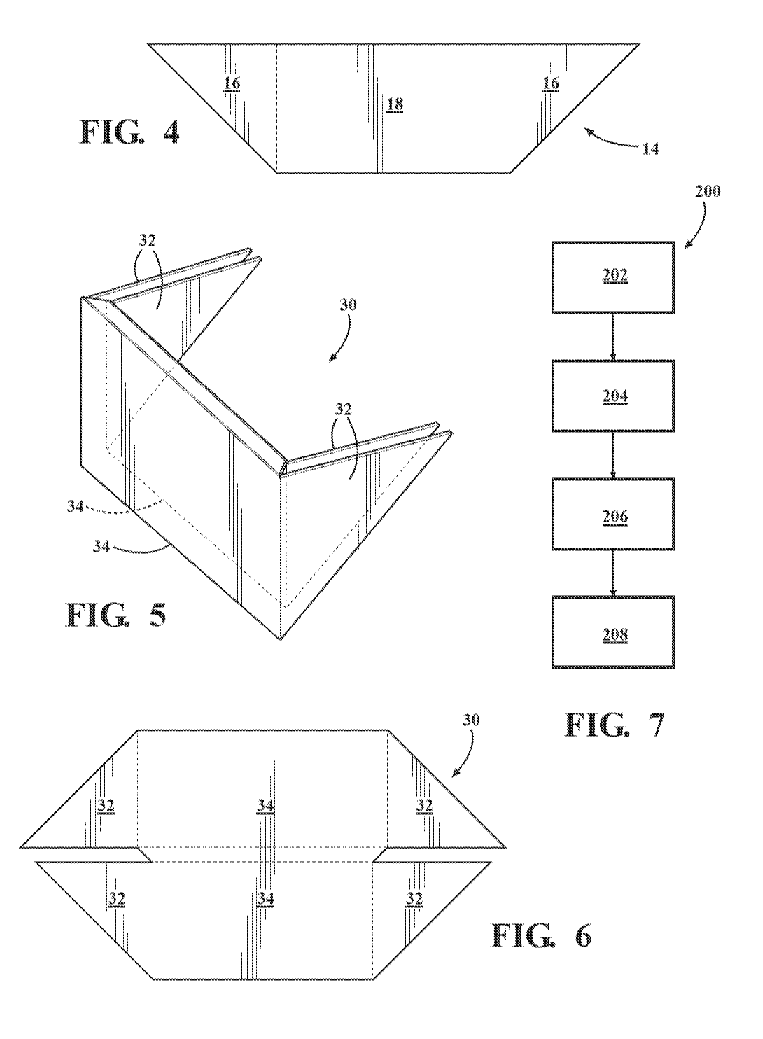

Referring to FIG. 5, a reinforcement component 30, according to another embodiment of the present invention, is shown. The reinforcement component 30 has multiple side walls 32 and rear walls 34 that are all connected, as depicted in its unassembled or unformed state in FIG. 6, where the dashed lines again represent locations at which the unassembled or unformed reinforcement component 30 should be bent to form its final configuration. For ease of reference, the reinforcement component 30 is not shown with any ribs or apertures. However, it should be appreciated that the reinforcement component 30 may include the same features as the reinforcement component 14 described above.

As an alternative to the reinforcement component 30, the oil pan assembly 10 may instead implement multiple reinforcement components 14 stacked from the interior of the oil pan assembly 10 to the exterior. The dimensions will have to be such that the walls of each of the reinforcement components 14 do not interfere with each other, and the overmold material will be able to flow between the walls of the reinforcement components 14. The oil pan assembly 10 may implement as many reinforcement components 14 that may fit within the overmold component 12 without affecting the integrity of the overall oil pan assembly 10.

Referring to FIG. 7, a method 200 of manufacturing the reinforced oil pan assembly 10 is shown as a flow diagram. Again, while method 200 is applied to manufacture an oil pan, it should be appreciated that method 200 may be applied to various injection-molded parts.

Method 200 begins with step 202, in which the reinforcement component 14, in its unformed state as depicted in FIG. 4, is cut from a sheet of material. As explained above, the material may be a layered-sheet composite, such as a matrix of layered fiber including, but not limited to, carbon fiber, hemp fiber, and the like, overmolded with a base polymer. In other embodiments, the material may be a metallic substance, including, but not limited to, sheet metal, foam metal, and the like. Furthermore, the sheet of material may be undulated, forming ribs 20 on the interior surface and/or exterior surface.

In embodiments where the reinforcement component 14 has apertures 22, the apertures 22 may be cut or punched either before or after the reinforcement component 14 is cut from the sheet of material in step 202.

After step 202, method 200 proceeds to step 204 in which the reinforcement component 14, in its unformed state, is folded to form its final configuration.

After step 204, method 200 proceeds to step 206 in which the reinforcement component 14 is placed in a mold of the oil pan for the injection molding process. Steps 202 through steps 206 may be repeated as many times as there are desired reinforcement components 14.

After step 206, method 200 proceeds to step 208 in which the material of the overmold component 12 is injected into the oil pan mold. The reinforcement component 14 is embedded at least partially within the overmold component 12 by this process.

The detailed description and the drawings or figures are supportive and descriptive of the invention, but the scope of the invention is defined solely by the claims. While some of the best modes and other embodiments for carrying out the claimed invention have been described in detail, various alternative designs and embodiments exist for practicing the invention defined in the appended claims.

1. A reinforced oil pan assembly comprising:
at least one reinforcement component having:
at least one rear wall; and
at least two side walls, each side wall being connected to the at least one rear wall; and
an overmold component;
wherein the reinforcement component and the overmold component are bonded together via an injection molding process, and the reinforcement component is embedded within the overmold component.

2. The oil pan assembly of claim 1 wherein at least one of the walls of the at least one reinforcement component comprise at least one aperture to enhance the bonding between the overmold component and the at least one reinforcement component.

3. The oil pan assembly of claim 1 wherein at least a portion of at least one of the walls of the at least one reinforcement component is sufficiently undulated to form a plurality of ribs that enhance the bonding between the overmold component and the at least one reinforcement component.

4. The oil pan assembly of claim 3 wherein the ribs are substantially parallel with respect to each other.

5. The oil pan assembly of claim 1 wherein the side walls are substantially triangular.

6. A method for manufacturing a reinforced oil pan assembly, the method comprising:
cutting a panel from a sheet of material;
folding the panel to form a reinforcement component having:
at least one rear wall; and
at least two side walls, each side wall being connected to the at least one rear wall;
inserting the reinforcement component into a mold shaped to define an oil pan;
injection molding a composite material into the mold to form an overmold component;
wherein the reinforcement component is embedded at least partially within the overmold component.

7. The method of claim 6 further comprising punching at least one aperture in at least one of the walls of the reinforcement component.

8. The method of claim 6 wherein at least a portion of at least one of the walls of the reinforcement component is undulated to form a plurality of ribs.

9. The method of claim 8 wherein the plurality of ribs are substantially parallel with respect to each other.

10. The method of claim 6 wherein the at least two side walls are substantially triangular.

11. A structural insert for reinforcing an oil pan, the structural insert comprising:
at least one rear wall; and
at least two side walls, each side wall being connected to the at least one rear wall;
wherein the structural insert is bonded to an overmold of the oil pan, the structural insert being embedded at least partially within the overmold; and
wherein at least a portion of at least one of the walls is sufficiently undulated to form a plurality of ribs that enhance bonding between the structural insert and the overmold.

12. The structural insert of claim 11 wherein the walls comprise at least one aperture to further enhance the bonding between the structural insert and the overmold.

13. The structural insert of claim 11 wherein the plurality of ribs are substantially parallel with respect to each other.
